(19) United States
(12) Patent Application Publication
(10) Pub. No.: US 2008/0029122 A1
(43) Pub. Date: Feb. 7, 2008

(54) Power dental flosser

(76) Inventor: Zoltan Egeresi, Santa Cruz, CA (US)

Correspondence Address: Zoltan Egeresi, 5500 Coast Rd., Santa Cruz, CA, 95060, US

(21) Appl. No.: 11/474,600

(22) Filed: Jun. 26, 2006

(51) Int. Cl. A61C 15/04

(52) U.S. Cl. 132/322; 132/323

(57) ABSTRACT

The present invention of the Power Dental Flosser uses a looped dental floss driven by a small electric motor to provide a continuous cleaning motion for a better teeth cleaning experience. At least one of the spool is capable of rotating with an attached tooth brush or with a tooth polishing what could be rotated in and out. The disposable dental loop is strong, made from naturally waxy polymer material preferably from a biodegradable thin-gauged high-density polyethylene (HDPE) or similar material.

### CROSS REFERENCE TO RELATED APPLICATIONS

U.S. Pat. No. 5,186,191 by Robert J Loubier shows a motor driven dental floss applicator where one long piece of the dental floss is used and spooled up on power driven reel. U.S. Pat. No. 3,734,107 by Thierman does a similar spooling and take up function without motor. U.S. Pat. No. 4,706,695 teaches a power driven dental floss tool with a complex feeding and take up gear assembly providing an additional oscillating motion.

### FEDERALLY SPONSORED RESEARCH AND DEVELOPMENT

Not applicable

### BACKGROUND OF THE INVENTION

Field of the Invention

This invention relates to Dental Floss tools, current US class 132/92, 132/322, 132/321. There are several prior art dental floss applicators on the marker with different degree of commercial success. In all cases, the floss needs to be stretched out, there are fixed throw away types, and some others with take up and supply reels, the power ones just stretch the floss on to the uptake real until the supply reel is exhausted or in most cases the floss breaks several times it is cumbersome to reload the floss again. My invention provides a novel solution for flossing by using a power driven continuously rotating replaceable dental floss.

### BRIEF SUMMERY OF THE INVENTION

The object of this invention is to create easier and more powerful way to floss the teeth. This invention uses a closed dental floss loop with or without bristles as part of the dental floss loop. Battery operated electric motor rotates a drum driving the dental floss ring looped around three wheels. Flossing loops are easily replaceable as one of the wheel is supported by a spring to provide proper tension, flossing loops are disposable. At least one of the wheel has attachable dental brush or tooth polishing cap which rotates as the dental loop is driving it.

### BRIEF DESCRIPTION OF THE INVENTION

The Power Dental Flosser uses disposable, power driven rotating flossing loops (9). Motor (16) drives wheel (14) and drum (13) to reduce speed and increase power. Dental floss is wrapped around drum (13) upper spools (7) and lower spool (3) which is spring loaded (2) to keep the flossing loop in proper tension. Flossing can be done in two places, top (A) and on side (B). Flossing loop may be a simple flossing material, or it can be made with short bristles (8) to improve inter dental cleaning. One of the top wheel is on a rotateable, pivotable support with a detachable buffing or tooth brush attachment, three in one dental system, flosser, brush, and polisher.

### DETAILED DESCRIPTION OF THE INVENTION

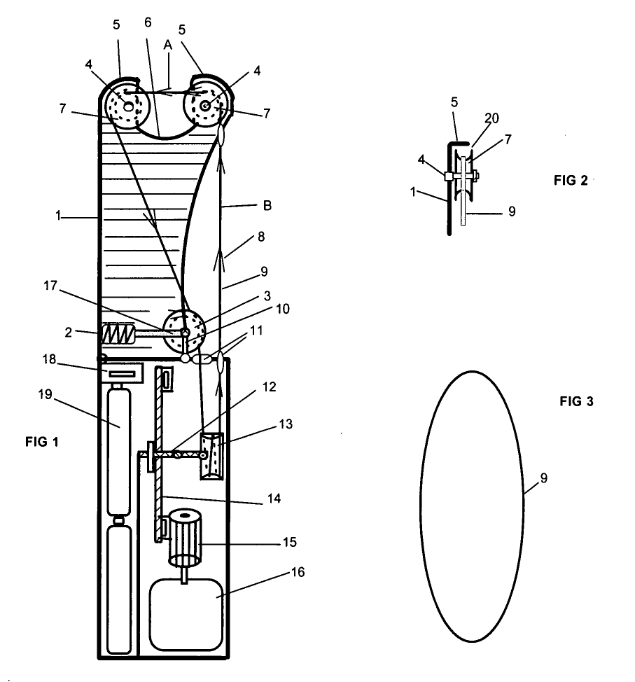

The elected invention is FIG. 1 (top view) on sheet 1 of 4, the other sheets describe the components of the new art in detail. This is a three in one dental hygiene system.

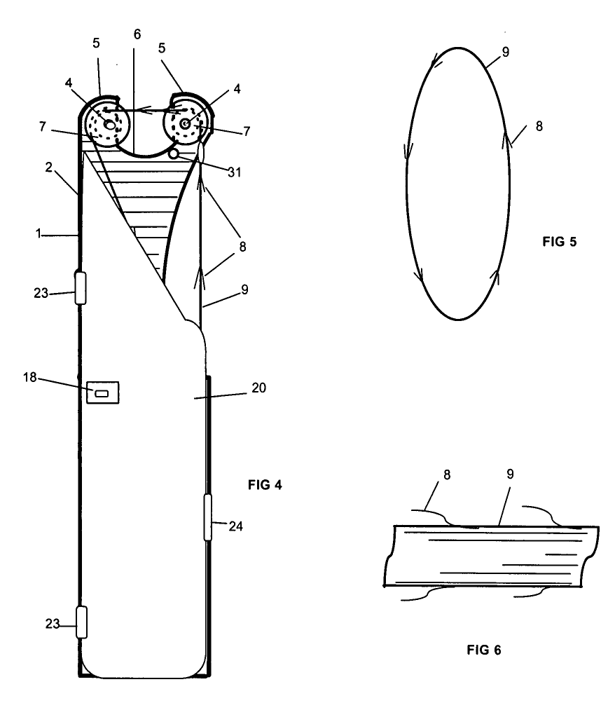

My invention the Power Dental Flosser comprises of case (1) electric motor (16) with gear (15) driving a larger gear (14) rotating around shaft (12) and rotates floss driving drum (13). This Power Dental Flosser uses disposable rotating flossing loops (9) FIGS. 1 and 3 which is wrapped around the drum at least twice to prevent slipping. Bottom cover has two openings(11) for the dental floss below top cover (20) FIG. 4 sheet 2 of 4, than guided trough spring loaded tension roller FIG. 1 (3) and the two upper rollers (7) supported by a shaft or screws (4).

Tension is provided by spring (2) as it keeps the roller extended with support arm (17) as it is pivoted by an another support arm (10).

Flossing can be done in two places, on top (A) between the two rollers, or on the side (B). Bottom case on top is indented (6) and wide enough to allow room for the widest tooth. Flossing loop may be simple flossing waxy polymer material FIG. 3 (9) or high density polyethylene (HDPE) with several short bristles FIGS. 5, 6 (8), floss with short bristles “hairy” flossing loop to improve inter dental cleaning.

In the basic operational mode the upper two rollers (7) are being in fixed position in the frame (1) by shaft (4), or they could be fixed by screws (4) allowing the wheels (7) to rotate. The top of the frame at (5) is curved around the reel (7) to prevent the spinning wheel touching the gums.

FIG. 2 also shows a gap (20) sufficient in size for easy floss insertion and removal.

FIG. 4 shows the cover (20) with two hinges (23) and latch (24) in closed position.

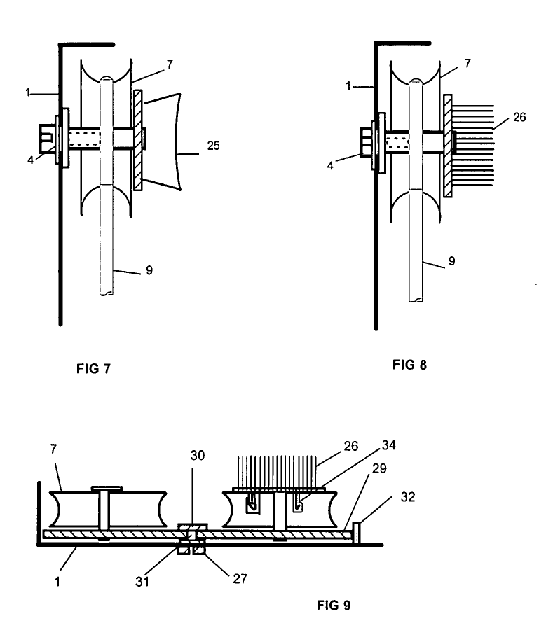

FIG. 7 sheet 3 of 4 shows one of the reel (7) with the rotating dental floss loop (9) with the attached tooth polisher cup (25), FIG. 8 has a rotateable dental brush(26).

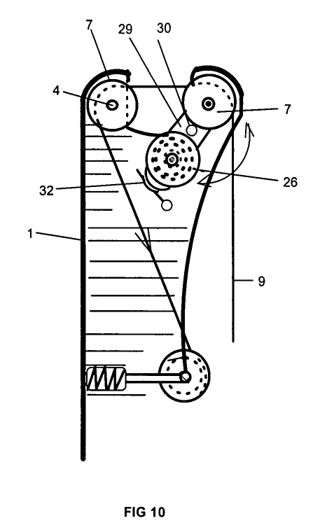

In case if user wants to have tooth brush attachment, to prevent crowding inside the mouth the brushing roller may be located on a rotateable plate side view FIG. 9 sheet 3 of 4 and top view FIG. 10 sheet 4 of 4. Regular flossing reel (7) is rotateable attached to rotateable plate (29) with the brush wheel (26) at hole (31) with screw (27) and nut(30) than locks into position with a spring (32). FIG. 9 further shows the dental brush (26) held into the rotating wheel (7) by flexible clips (34).

What I claim as my invention is Power Dental Flosser comprising of:

1. An electric motor driven rotating reduction gear assembly with a small drum which drives a looped dental floss as it is wrapped around two rotateably supported upper spools;
body of casing which bends around above mentioned upper spools to prevent wheel rubbing to gums, but allows easy loading of dental flossing loop;
at least one spring loaded rotateably supported reel to keep looped floss in constant tension and it is partially retractable for the dental flossing loop insertion;
a battery holder for energy source with an on off switch.

2. Dental floss manufactured as a disposable inter dental cleaning closed loop; dental loop for extra cleaning made from strong, naturally waxy polymer or similar material, high density polyethylene (HDPE) with several short bristles inserted as part of the rotating loop to assure better plaque cleaning.

3. Rotating wheel is secured to the base plate with a shaft or screws as to remain rotateable as a single wheel, or rotateable on a small pivotal plate with dual wheels locked into position by a spring and at least one of the wheel has polishing or dental brush attached to it.
